(19) United States
(12) Patent Application Publication
(10) Pub. No.: US 2022/0374567 A1
(43) Pub. Date: Nov. 24, 2022

(54) METHOD FOR GENERATING A COMPONENT MESH, USE OF A COMPONENT MESH, COMPUTER PROGRAM AND COMPUTER-READABLE MEDIUM

(71) Applicant: Siemens Industry Software NV, Leuven (BE)

(72) Inventor: Guy Robert, Liège (BE)

(21) Appl. No.: 17/767,149

(22) PCT Filed: Oct. 15, 2019
(86) PCT No.: PCT/EP2019/077843

§ 371 Date: Apr. 7, 2022

(51) Int. Cl. G06F 30/20; G06T 17/20

(52) U.S. Cl. CPC G06F 30/20; G06T 17/205; G06F 2113/10

(57) ABSTRACT

A method is disclosed for generating a component mesh of a component that may be built-up layer by layer in an additive manufacturing build-up process. The method includes providing a three-dimensional initial component mesh composed of initial mesh elements of uniform shape which include initial mesh nodes and initial mesh edges extending between the initial mesh nodes; slicing the initial component mesh by at least one cutting plane such that initial mesh elements are divided into at least two resulting mesh elements, wherein at the intersection points of the at least one cutting plane with edges of initial mesh elements resulting mesh nodes are defined; determining the position of each initial mesh element with respect to each cutting plane and thus which initial mesh element is divided into resulting mesh elements and which is not; and determining the shape of each resulting mesh element.

The present patent document is a § 371 nationalization of PCT Application Serial No. PCT/EP2019/077843, filed Oct. 15, 2019, designating the United States, which is hereby incorporated by reference.

### TECHNICAL FIELD

The disclosure refers to a method for generating a component mesh of a component which may be used in simulating the component and/or an additive manufacturing build-up process of the component.

### BACKGROUND

Methods are known in which a component mesh of a component is generated by dividing the volume of the component into a finite number of elements, especially tetrahedron-shaped elements, and thus discretizing the volume of the component. However, the boundary of the component is only reproduced relatively inaccurately using such methods.

In recent years, additive manufacturing build-up processes, also known as generative manufacturing or three-dimensional (3D) printing processes, in particular used for the fast and cost-effective production of both prototypes and end products, have become increasingly important. These processes, which are summarized under the term rapid prototyping, enable in particular the direct production of individual components on the basis of digital construction data, especially computer aided design (CAD) data of the components. Production may be carried out using liquid, strip, wire, and powder starting materials, which is why there are few restrictions with regard to the component geometries and component materials. Thanks to the layer-by-layer production, previously unattainable geometries may be produced with these processes.

In the case of metallic powder starting materials, primarily two groups of additive manufacturing build-up processes are known. These are on the one hand powder bed fusion-based build-up processes, such as the Selective Laser Melting (“SLM”) process or the Selective Electron Beam Melting (“SEBM”) process, and on the other hand powder feeding processes, such as the Laser Material Deposition (“LMD”) process.

In the SLM process, a metal powder to be processed is applied in a thin layer to a build-up platform and then completely melted locally using a laser radiation so that the metal powder forms a solid material layer after solidification. In order to enable a desired component to be manufactured in layers, the build-up platform is then lowered by the amount of one layer thickness, metal powder is applied again, and a laser beam is then directed over the new metal powder layer. This procedure is repeated until the desired component is completed. The SEBM process is almost identical to the SLM process, except that the metal powder is melted using an electron beam instead of laser radiation.

In addition to the processes already mentioned, there are also those in which the metal powder is melted using a plasma jet, to name just one example.

In the case of a component which is to be build-up layer by layer in an additive manufacturing build-up process, methods are known in which a layered component mesh, (e.g., a component mesh composed of several mesh layers), is generated by building-up the component mesh layer by layer with tetrahedron-shaped elements. The meshing algorithms used in such methods are basically automatic but fail regularly. In the case of failure of the automatic meshing algorithms, manual operations are necessary which require a good knowledge of the meshing techniques used. For example, it may be necessary to globally modify the number of layers or locally modify the thickness of some layers. The problem is that failures cannot be predicted. Consequently, the meshing task may become a tedious trial-and-error operation without a guarantee of success. Moreover, the meshing algorithms used contain many floating-point operations why the meshing algorithms are relatively slow. In summary, the known methods for generating a layered component mesh are resource intensive.

A component mesh may be used in simulating the respective component and/or an additive manufacturing build-up process of the respective component, in particular based on a Finite Element Method (“FEM”). For example, it is known to carry out thermal, mechanical and/or thermo-mechanical simulations of the additive manufacturing build-up process. This allows to get information on thermal issues during the later build-up and to capture a preview on distortions that might arise due to the complex thermo-mechanical process during the additive manufacturing build-up process.

From WO 2016/044006 A1 a method to adjust a CAD geometry tessellation into a layer-by-layer representation to enable additive manufacturing machine control is known.

### SUMMARY AND DESCRIPTION

The scope of the present disclosure is defined solely by the appended claims and is not affected to any degree by the statements within this summary. The present embodiments may obviate one or more of the drawbacks or limitations in the related art.

It is an object of the present disclosure to provide an alternative method for generating a component mesh that does not have the disadvantages of the methods of the prior art.

This object is solved by a method for generating a component mesh of a component, in particular a layered component mesh of a component, such as a component which is to be built-up layer by layer in an additive manufacturing build-up process. The component mesh may be used in simulating the component and/or the additive manufacturing build-up process of the component. The method includes act a): providing a three-dimensional initial component mesh composed of initial mesh elements of uniform shape which include initial mesh nodes and initial mesh edges extending between the initial mesh nodes. The method further includes act b): slicing the initial component mesh by at least one cutting plane such that initial mesh elements are divided into at least two resulting mesh elements, wherein at the intersection points of the at least one cutting plane with edges of initial mesh elements resulting mesh nodes are defined. The method further includes act c) determining the position of each initial mesh element with respect to each cutting plane and thus which initial mesh element is divided into resulting mesh elements and which is not, and determining the shape of each resulting mesh element.

In other words, a component mesh of a component is generated by using an initial component mesh composed of initial mesh elements, which may be already available from digital construction data, (e.g., CAD data), for the component or which is generated in particular based on these digital construction data, and the initial component mesh is sliced by at least one cutting plane. In this way, initial mesh elements are divided into at least two resulting mesh elements whose shape is determined. As a result, the shapes of all elements of the resulting component mesh are known. The method may be performed completely automated and does not require any manual operations. In one example, the method does not require more input than the initial component mesh and the number of mesh layers to create. The thickness of the layers may be variable from one layer to the other without loss of generality. Moreover, the method is faster as compared to the known methods. For example, it takes about 15 seconds to create 150 layers in a mesh with 2 million elements on an Intel Xeon E5-2680 processor. It thus may take more time to save the new mesh on a disk than to create it. The algorithm used in the method may contain fewer floating-point operations as compared to the meshing algorithms of the known methods. This may contribute to the higher speed of the method as compared to the known methods.

According to the disclosure, act b) includes slicing the initial component mesh by several cutting planes which run parallel to each other and are in particular uniformly spaced from each other to generate a component mesh composed of several mesh layers superimposed upon each other. The component mesh may be composed of more than hundred mesh layers, between 100 and 200 mesh layers, or 100 mesh layers.

Act b) may include selecting the distance between the cutting planes such that each initial mesh element is cut maximum three times, in particular maximum two times.

In an embodiment, act a) includes providing a tetrahedron mesh composed of tetrahedron-shaped mesh elements each having four initial mesh nodes.

Act c) may include calculating for each initial mesh element a cutting code cc or cutting codes cc's which indicate(s) the position(s) of the initial mesh element with respect to the cutting plane(s).

Calculating the cutting code cc of an initial mesh element related to a particular cutting plane in act c) may include: creating an unsorted list nᵤₛ={n_{us,1}, n_{us,2}, n_{us,3}, . . . , n_{us,i}} of i characters n_{u,s,1}, n_{us,2}, n_{us,3}, . . . , n_{us,i}, such as numbers or letters, which represent the initial mesh nodes of the initial mesh element; assigning a cutting index m_{us,1}, m_{us,2}, m_{us,3}, . . . , m_{us,i} to each initial mesh node, wherein an initial mesh node which is below the particular cutting plane is assigned the cutting index 0, an initial mesh node which is in the particular cutting plane is assigned the cutting index 1 and an initial mesh node which is above the particular cutting plane is assigned the cutting index 2; creating an unsorted list mᵤₛ={m_{us,1}, m_{us,2}, m_{us,3}, . . . , m_{us,i}} of the i cutting indices m_{us,1}, m_{us,2}, m_{us,3}, . . . , m_{us,i}; sorting the cutting indices m_{us,1}, m_{us,2}, m_{us,3}, . . . , m_{us,i} of the list mᵤₛ={m_{us,1}, m_{us,2}, m_{us,3}, . . . , m_{us,i}} in ascending order to create a sorted list mₛ{m_{s,1}, m_{s,2}, m_{s,3}, . . . , m_{s,i}} and permutating the characters n_{us,1}, n_{us,2}, n_{us,3}, . . . , n_{us,i} of the list nᵤₛ={n_{us,1}, n_{us,2}, n_{us,3}, . . . , n_{us,i}} to create a sorted list nₛ={n_{s,1}, n_{s,2}, n_{s,3}, . . . , n_{s,i}} which is sorted in correspondence with the sorted list mₛ={m_{s,1}, m_{s,2}, m_{s,3}, . . . , m_{s,i}}; and calculating the cutting code cc using the sorted cutting indices m_{s,1}, m_{s,2}, m_{s,3}, . . . , m_{s,i}.

Each cutting plane is defined by one of its points and by its normal vector and determines two half spaces. According to one possible definition, points that are on one side of the cutting plane with respect to the normal vector of the cutting plane are said to be above the cutting plane and points on the other side are said to be below the cutting plane.

If a tetrahedron mesh is provided as an initial component mesh, it is possible that the cutting code cc (which has one to four digits) is calculated using the following formula:

cc=m_{s,1}*1000+m_{s,2}*100+m_{s,3}*10+m_{s,4}.

The list mₛ={m_{s,1}, m_{s,2}, m_{s,3}, . . . , m_{s,i}} is thus condensed to a single number, namely the cutting code cc.

Advantageously, in act c), for each initial mesh element, it is determined whether the respective initial mesh element is cut by one or more cutting planes and thus divided into resulting mesh elements or not based on the calculated cutting codes cc's. In this embodiment, when a cutting code cc is 0 or 2222, the respective cutting plane does not cut the respective initial mesh element; when a cutting code cc is 1 or 1222, one initial mesh node of the respective initial mesh element belongs to the respective cutting plane; when a cutting code cc is 11 or 1122, one edge of the respective initial mesh element belongs to the respective cutting plane; when a cutting code cc is 111 or 1112, one face of the respective initial mesh element belongs to the respective cutting plane; when a cutting code cc is 2, 12, 22, 112, 122 or 222, the respective initial mesh element is cut by the respective cutting plane; and when a cutting code cc is 1111, the respective initial mesh element is degenerated.

In the context of the case, in which a cutting code cc is 1111, (e.g., the initial mesh nodes of the respective initial mesh element are in the respective cutting plane), the expression “degenerated” means that the respective initial mesh element is flat. In practice, such zero-volume element is not created by the meshing algorithms.

If it is determined in act c) that a respective initial mesh element is cut by only one cutting plane and thus divided into two resulting mesh elements, the shape of the two resulting mesh elements may be determined by the cutting code cc associated with the respective initial mesh element and the cutting plane which cuts the respective initial mesh element. In this embodiment, when the cutting code cc is 2 or 222, this indicates that the cutting plane divides the initial mesh element in a triangular prism and a tetrahedron; when the cutting code cc is 12 or 122, this indicates that the cutting plane divides the initial mesh element in a quadrangular pyramid and a tetrahedron; when the cutting code cc is 22, this indicates that the cutting plane divides the initial mesh element in two triangular prisms; and when the cutting code cc is 112, this indicates that the cutting plane divides the initial mesh element in two tetrahedrons.

In the following Table 1, possible cutting codes for a tetrahedron-shaped initial mesh element and their meanings are summarized.

TABLE 1

| cutting | |
|---|---|
| code | meaning |
| 0 | no cut |
| 1 | one node belongs to the cutting plane |
| 2 | the cutting plane divides the tetrahedron in a triangular prism |
| | and a tetrahedron |
| 11 | one edge belongs to the cutting plane |
| 12 | the cutting plane divides the tetrahedron in a quadrangular |
| | pyramid and a tetrahedron |
| 22 | the cutting plane divides the tetrahedron in two triangular |
| | prisms |
| 111 | one face belongs to the cutting plane |
| 112 | the cutting plane divides the tetrahedron in two tetrahedrons |
| 122 | the cutting plane divides the tetrahedron in a quadrangular |
| | pyramid and a tetrahedron |
| 222 | the cutting plane divides the tetrahedron in a triangular prism |
| | and a tetrahedron |
| 1111 | the initial tetrahedron is degenerated (flat) |
| 1112 | one face belongs to the cutting plane |
| 1122 | one edge belongs to the cutting plane |
| 1222 | one node belongs to the cutting plane |
| 2222 | no cut |

Because each initial mesh node may be in the respective cutting plane, below it or above it, there are in theory 3⁴=81 ways to position a tetrahedron with respect to the respective cutting plane and thus 81 possibilities to be considered. As may be seen from Table 1, in the method, there is a limited number of cutting codes and there are only four different ways to divide the tetrahedron by the respective cutting plane. The case where all initial mesh nodes are in the respective cutting plane, (e.g., cutting code 1111), may be omitted in practice. Thus, by calculating the positions of its nodes with respect to the respective cutting plane, it may be simply determined if the tetrahedron is divided and how. The method thus significantly reduces the number of possibilities which have to be considered.

If it is determined in act c) that a respective initial mesh element is cut by at least two cutting planes, a first cutting code ccl associated with the respective initial mesh element and a first cutting plane and a second cutting code cc2 associated with the respective initial mesh element and a second cutting plane, the first and second cutting planes being adjacent to each other and cut the respective initial mesh element, may be considered to determine the shape of one or two resulting mesh elements delimited by the first and second cutting planes between the first and second cutting planes within the respective initial mesh element.

In this embodiment, when the first cutting code cc1 is 2, 12 or 112 and the second cutting code cc2 is 0 or 1, or when the first cutting code ccl is greater than 1111 and the second cutting code cc2 is 0, 1, 11, 12, 111, 112, 122 or 222, this indicates that a tetrahedron is delimited by the first and second cutting planes.

When the first cutting code cc1 is 2, 12 or 112 and the second cutting code cc2 is 2, or when the first cutting code cc1 is 22 and the second cutting code cc2 is 0, 1 or 11, or when the first cutting code cc1 is 222 and the second cutting code cc2 is 0, 1, 11 or 111, or when the first cutting code cc1 is 222 and the second cutting code cc2 is 112, 122 or 222, or when the first cutting code cc1 is greater than 1111 and the second cutting code cc2 is 2 or 22, this indicates that a triangular prism is delimited by the first and second cutting planes.

When the first cutting code cc1 is 122 and the second cutting code cc2 is 0, 1 or 11, this indicates that a quadrangular pyramid is delimited by the first and second cutting planes.

When the first cutting code cc1 is 22 and the second cutting code cc2 is 22, this indicates that a hexahedron is delimited by the first and second cutting planes,

When the first cutting code cc1 is 22 or 122 and the second cutting code cc2 is 12, or when the first cutting code cc1 is 122 and the second cutting code cc2 is 22, this indicates that a degenerated hexahedron is delimited by the first and second cutting planes.

When the first cutting code cc1 is 22 and the second cutting code cc2 is 2, or when the first cutting code cc1 is 222 and the second cutting code cc2 is 22, this indicates that a degenerated hexahedron and a tetrahedron are delimited by the first and second cutting planes.

When the first cutting code cc1 is 122 and the second cutting code cc2 is 2, or when the first cutting code cc1 is 222 and the second cutting code cc2 is 12, this indicates that two triangular prisms, one of which is degenerated, are delimited by the first and second cutting planes, and

When the first cutting code cc1 is 222 and the second cutting code cc2 is 2, this indicates that two triangular prisms are delimited by the first and second cutting planes.

In the following Table 2, all possible combinations of cutting codes cc1 and cc2 for a tetrahedron-shaped initial mesh element and their meanings are summarized.

TABLE 2

| | | | meaning, i.e. resulting mesh |
|---|---|---|---|
| | | | element(s) delimited by the |
| No. | cc1 | cc2 | two cutting planes |
| 1 | 2 | 0 or 1 | tetrahedron |
| 2 | 2 | 2 | triangular prism |
| 3 | 12 | 0 or 1 | tetrahedron |
| 4 | 12 | 2 | triangular prism |
| 5 | 22 | 0, 1 or 11 | triangular prism |
| 6 | 22 | 2 | degenerated hexahedron and |
| | | | tetrahedron |
| 7 | 22 | 12 | degenerated hexahedron |
| 8 | 22 | 22 | hexahedron |
| 9 | 112 | 0 or 1 | tetrahedron |
| 10 | 112 | 2 | triangular prism |
| 11 | 122 | 0, 1 or 11 | quadrangular pyramid |
| 12 | 122 | 2 | two triangular prisms (one is |
| | | | degenerated) |
| 13 | 122 | 12 | degenerated hexahedron |
| 14 | 122 | 22 | degenerated hexahedron |
| 15 | 222 | 0, 1, 11 or 111 | triangular prism |
| 16 | 222 | 2 | two triangular prisms |
| 17 | 222 | 12 | two triangular prisms (one is |
| | | | degenerated) |
| 18 | 222 | 22 | degenerated hexahedron and |
| | | | tetrahedron |
| 19 | 222 | 112 | triangular prism |
| 20 | 222 | 122 | triangular prism |
| 21 | 222 | 222 | triangular prism |
| 22 | greater than 1111 | 0, 1, 11 or 111 | tetrahedron |
| 23 | greater than 1111 | 2 | triangular prism |
| 24 | greater than 1111 | 12 | tetrahedron |
| 25 | greater than 1111 | 22 | triangular prism |
| 26 | greater than 1111 | 112 | tetrahedron |
| 27 | greater than 1111 | 122 | tetrahedron |
| 28 | greater than 1111 | 222 | tetrahedron |

A degenerated hexahedron is a hexahedron in which one edge is reduced to a point. Likewise, a degenerated triangular prism is a triangular prism in which one edge is reduced to a point. As may be seen from Table 2, the number of possible configurations for two cutting planes has been reduced from 3⁸=6561 in theory to 28. The above-mentioned method thus simplifies the actual task of listing exhaustively all the possible positions of the nodes of the tetrahedron with respect to the cutting planes. The “a priori” classification of all the possible ways to cut a tetrahedron by two cutting planes contributes to the fact that the method is performed completely automated.

The cases in which two resulting mesh elements are delimited by the first and second cutting planes within the respective initial mesh element may be due to the fact that, when the trace of the first and second cutting planes in a tetrahedron face of the respective initial mesh element defines a pentagon, this pentagon is divided in a quadrangle, (e.g., a rectangle), and a triangle. This is advantageous because in simulating the component and/or the additive manufacturing build-up process of the component based on a FEM method, only triangular or quadrangular mesh element faces may be allowed. In this way, it is provided that the resulting mesh elements correspond to the elementary shapes available in FEM methods.

In another embodiment, the method includes act d): projecting at least one initial mesh node, especially all initial mesh nodes, whose distance to a cutting plane is less than a predetermined threshold value, in particular less than one tenth of the smallest resulting mesh element thickness near this initial mesh node, into the cutting plane.

Act d) allows to avoid tiny and/or small resulting mesh elements which may otherwise be a problem in particular in later simulations.

In certain examples, the method further includes act e): saving all resulting mesh elements which replace the initial mesh elements on a storage medium, in particular on a disk.

In yet another embodiment, the at least one cutting plane is a boundary plane of a boundary of the component and resulting mesh elements which are outside the boundary are excluded from the component mesh. In this way, the generated component mesh more accurately reproduces the component as compared to the known methods for generating a component mesh.

The disclosure also regards a use of a component mesh of a component generated according to the method for simulating, especially thermally, mechanically and/or thermo-mechanically simulating, the component and/or an additive manufacturing build-up process, in particular a powder bed fusion-based build-up process, of the component.

The disclosure furthermore regards a computer program includes instructions which, when the program is executed by at least one computer, cause the at least one computer to carry out the method.

Moreover, the disclosure regards a computer-readable medium including instructions which, when executed on at least one computer, cause the at least one computer to perform the acts of the method.

The computer-readable medium may be a CD-ROM, DVD, USB memory, or flash memory. A computer-readable medium should not be understood exclusively as a physical medium, but that such a medium may also exist in the form of a data stream and/or a signal representing a data stream.

### BRIEF DESCRIPTION OF THE DRAWINGS

Further features and advantages of the present disclosure become clear from the following description of embodiments with reference to the enclosed drawings.

FIG. 1 depicts a schematic illustration of a component for which a component mesh is to be generated.

FIG. 2 depicts a schematic illustration of a part of a component mesh of the component from FIG. 1 which has been generated by a method according to an embodiment of the present disclosure.

FIG. 3 depicts a schematic illustration of a tetrahedron which is divided into two resulting mesh elements.

FIG. 4 depicts a schematic illustration of a tetrahedron which is divided into three resulting mesh elements.

### DETAILED DESCRIPTION

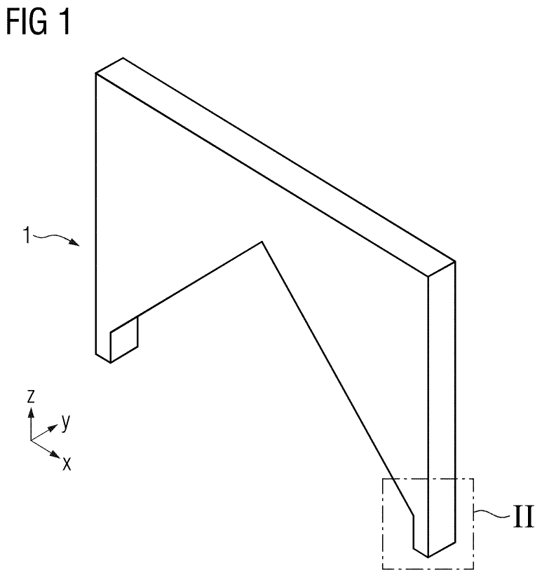

FIG. 1 shows a schematic illustration of an arch-like component 1 which is to be build-up layer by layer in an additive manufacturing build-up process, in particular a powder bed fusion-based build-up process.

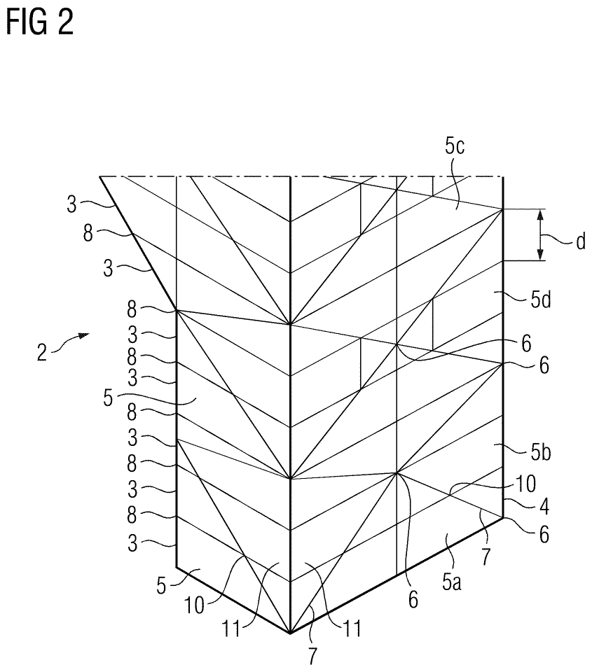

FIG. 2 shows a schematic illustration of a part of a layered component mesh 2, e.g., a component mesh 2 composed of several mesh layers 3 which are superimposed upon each other.

The layered component mesh 2 may be used for simulating the additive manufacturing build-up process of the component 1 and has been generated by a method according to an embodiment described below.

The method for generating the layered component mesh 2 starts with providing a tetrahedron mesh 4 as a three-dimensional initial component mesh composed of tetrahedron-shaped initial mesh elements, in short tetrahedrons 5, which each include four initial mesh nodes 6 and six initial mesh edges 7 extending between or rather connecting the initial mesh nodes 6. The tetrahedron mesh 4 may be already available from digital construction data, especially CAD data, for the component or may be generated especially based on such digital construction data.

The tetrahedron mesh 4 is then sliced by a plurality of cutting planes 8 which run parallel to each other and are uniformly spaced from each other such that each tetrahedron 5 of the tetrahedron mesh 4 is divided into at least two resulting mesh elements 9. In this example, the distance d between two adjacent cutting planes 8 is selected such that each tetrahedron 5 is cut maximum three times. At the intersection points of the cutting planes 8 with edges 7 of tetrahedrons 5, resulting mesh nodes 10 are defined.

However, the desired layered component mesh 2 also includes the knowledge of the shape of the resulting mesh elements 9. Therefore, in a next act, the position of each tetrahedron 5 with respect to each cutting plane 8 and thus which tetrahedron 5 is divided into resulting mesh elements 9 and which is not, is determined. More precisely, for each tetrahedron 5, cutting codes cc's which indicate the positions of the tetrahedron 5 with respect to the cutting planes 8 are calculated. In order to calculate the cutting code cc of a tetrahedron 5 related to a particular cutting plane 8, first an unsorted list nᵤₛ={n_{us,1}, n_{us,2}, n_{us,3}, n_{us,4}} of four characters is created, in this example numbers n_{us,1}, n_{us,2}, n_{us,3}, n_{us,4} which represent the four initial mesh nodes 6 of the tetrahedron 5. A cutting index m_{us,1}, m_{us,2}, m_{us,3}, m_{us,4} is then assigned to each initial mesh node 6, wherein an initial mesh node 6 which is below the particular cutting plane 8 is assigned the cutting index 0, an initial mesh node 6 which is in the particular cutting plane 8 is assigned the cutting index 1, and an initial mesh node 6 which is above the particular cutting plane 8 is assigned the cutting index 2. An unsorted list mᵤₛ={m_{us,1}, m_{us,2}, m_{us,3}, m_{us,4}} of the four cutting indices m_{us,1}, m_{us,2}, m_{us,3}, m_{us,4} is created. In a next act, the cutting indices m_{us,1}, m_{us,2}, m_{us,3}, m_{us,4} of the list mᵤₛ={m_{us,1}, m_{us,2}, m_{us,3}, m_{us,4}} are sorted in ascending order to create a sorted list mₛ={m_{s,1}, m_{s,2}, m_{s,3}, m_{s,4}} and the numbers n_{us,1}, n_{us,2}, n_{us,3}, n_{us,4} of the list nᵤₛ={n_{us,1}, n_{us,2}, n_{us,3}, n_{us,4}} are permutated to create a sorted list nₛ={n_{s,1}, n_{s,2}, n_{s,3}, n_{s,4}}, which is sorted in correspondence with the sorted list mₛ={m_{s,1}, m_{s,2}, m_{s,3}, m_{s,4}}. Finally, the cutting code cc which has one to four digits is calculated using the sorted cutting indices m_{s,1}, m_{s,2}, m_{s,3}, m_{s,4} and the following formula:

cc=m_{s,1}*1000+m_{s,2}*100+m_{s,3}*10+m_{s,4}

For each tetrahedron 5, it is determined whether the tetrahedron is cut by one or more cutting planes 8 and thus divided into resulting mesh elements 9 or not based on the calculated cutting codes. When a cutting code cc is 0 or 2222, the respective cutting plane 8 does not cut the respective tetrahedron 5. When a cutting code cc is 1 or 1222, one initial mesh node 6 of the respective tetrahedron 5 belongs to the respective cutting plane 8. When a cutting code cc is 11 or 1122, one initial mesh edge 7 of the respective tetrahedron 5 belongs to the respective cutting plane 8. When a cutting code is 111 or 1112, one initial mesh face 11 of the respective tetrahedron 5 belongs to the respective cutting plane 8. When a cutting code cc is 2, 12, 22, 112, 122 or 222, the respective tetrahedron 5 is cut by the respective cutting plane 8, and when a cutting code cc is 1111, the respective tetrahedron 5 is degenerated, e.g., flat.

As may be seen from FIG. 2, in the present example, the tetrahedrons 5 may be cut differently. For example, tetrahedron 5a is cut once, tetrahedron 5b is cut twice and tetrahedron 5c is cut three times. The number of times a tetrahedron 5 is cut may depend on the respective element size and the distance d between the cutting planes 8.

When it is determined that a respective tetrahedron 5 is cut by only one cutting plane 8 and thus divided into two resulting mesh elements 9, the shape of the two resulting mesh elements 9 is determined by the cutting code cc associated with the respective tetrahedron 5 and the cutting plane 8 which cuts the respective tetrahedron 5. When the cutting code cc is 2 or 222, this indicates that the cutting plane 8 divides the tetrahedron 5 in a triangular prism and a tetrahedron. When the cutting code cc is 12 or 122, this indicates that the cutting plane 8 divides the tetrahedron 5 in a quadrangular pyramid and a tetrahedron. When the cutting code cc is 22, this indicates that the cutting plane 8 divides the tetrahedron 5 in two triangular prisms, and when the cutting code cc is 112, this indicates that the cutting plane 8 divides the tetrahedron 5 in two tetrahedrons.

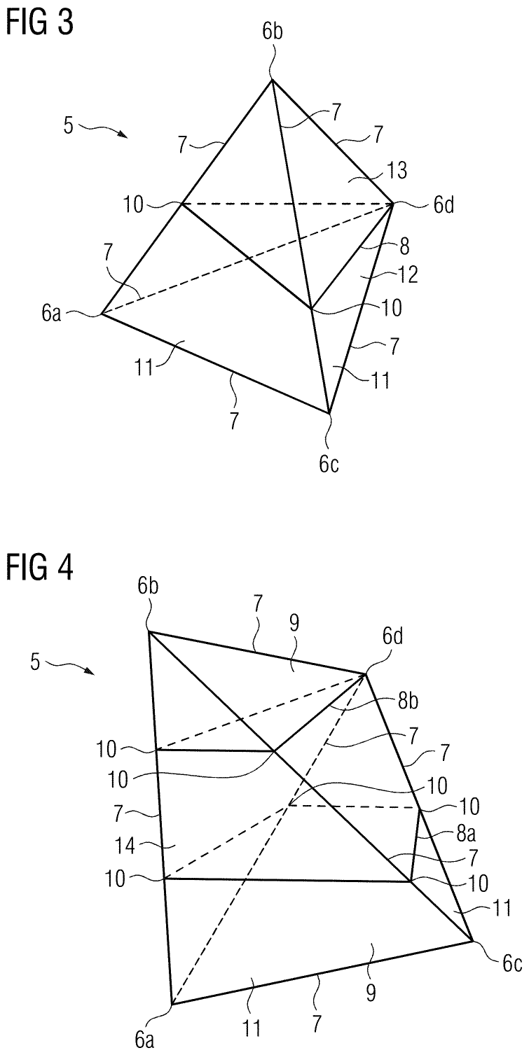

FIG. 3 is a schematic illustration of a tetrahedron 5 which is cut by only one cutting plane 8. In this example, initial mesh node 6a is represented by the number 43, initial mesh node 6b is represented by the number 24, initial mesh node 6c is represented by the number 212, and initial mesh node 6d is represented by the number 318 in the unsorted list nᵤₛ={43, 24, 212, 318}. The unsorted list of the cutting indices assigned to the initial mesh nodes 6a-d is mᵤₛ={0, 2, 0, 1}. The sorted list of the cutting indices is mₛ={0, 0, 1, 2} and the sorted list of the numbers representing the initial mesh nodes 6a-d is nₛ={43, 212, 318, 24}. This results in a cutting code cc=12, which indicates that the tetrahedron 5 is divided into a quadrangular pyramid 12 and a tetrahedron 13.

When it is determined that a respective tetrahedron 5 is cut by at least two, in this example two or three cutting planes 8, a first cutting code cc1 associated with the respective tetrahedron 5 and a first cutting plane 8 and a second cutting code cc2 associated with the respective tetrahedron 5 and a second cutting plane 8, the first and second cutting planes 8 being adjacent to each other and cut the respective tetrahedron 5, are considered to determine the shape of one or two resulting mesh elements 9 delimited by the first and second cutting planes 8 between the first and second cutting planes 8 within the respective tetrahedron 5. When the first cutting code cc1 is 2, 12 or 112 and the second cutting code cc2 is 0 or 1, or when the first cutting code cc1 is greater than 1111 and the second cutting code cc2 is 0, 1, 11, 12, 111, 112, 122 or 222, this indicates that a tetrahedron is delimited by the first and second cutting planes 8. When the first cutting code cc1 is 2, 12 or 112 and the second cutting code cc2 is 2, or when the first cutting code cc1 is 22 and the second cutting code cc2 is 0, 1 or 11, or when the first cutting code cc1 is 222 and the second cutting code cc2 is 0, 1, 11 or 111, or when the first cutting code cc1 is 222 and the second cutting code cc2 is 112, 122 or 222, or when the first cutting code cc1 is greater than 1111 and the second cutting code cc2 is 2 or 22, this indicates that a triangular prism is delimited by the first and second cutting planes 8. When the first cutting code cc1 is 122 and the second cutting code cc2 is 0, 1 or 11, this indicates that a quadrangular pyramid is delimited by the first and second cutting planes 8. When the first cutting code cc1 is 22 and the second cutting code cc2 is 22, this indicates that a hexahedron is delimited by the first and second cutting planes 8. When the first cutting code cc1 is 22 or 122 and the second cutting code cc2 is 12, or when the first cutting code cc1 is 122 and the second cutting code cc2 is 22, this indicates that a degenerated hexahedron is delimited by the first and second cutting planes 8. When the first cutting code cc1 is 22 and the second cutting code cc2 is 2, or when the first cutting code cc1 is 222 and the second cutting code cc2 is 22, this indicates that a degenerated hexahedron and a tetrahedron are delimited by the first and second cutting planes 8. When the first cutting code cc1 is 122 and the second cutting code cc2 is 2, or when the first cutting code cc1 is 222 and the second cutting code cc2 is 12, this indicates that two triangular prisms, one of which is degenerated, are delimited by the first and second cutting planes 8. Finally, when the first cutting code cc1 is 222 and the second cutting code cc2 is 2, this indicates that two triangular prisms are delimited by the first and second cutting planes 8.

When the trace of the first and second cutting planes 8 in a tetrahedron face 11 of the respective tetrahedron 5 defines a pentagon, this pentagon is divided into a quadrangle and a triangle. This results in one of the above-mentioned cases in which two resulting mesh elements 9 are delimited by the first and second cutting planes 8 within the respective tetrahedron 5, see for example tetrahedron 5d in FIG. 2.

FIG. 4 is a schematic illustration of a tetrahedron 5 which is cut by two cutting planes 8, namely a first cutting plane 8a and a second cutting plane 8b above the first cutting plane 8a. A first cutting code associated with the tetrahedron 5 and the first cutting plane 8a is cc1=22 and a second cutting code associated with the tetrahedron 5 and the second cutting plane 8b is cc2=12. This indicates that a degenerated hexahedron 14, (e.g., a hexahedron having one edge reduced to a point that corresponds to initial mesh node 6d), is delimited by the first and second cutting planes 8a, 8b.

In the above manner, the shape(s) of the resulting mesh element(s) 9 between pairs of adjacent cutting planes 8 which cut the respective tetrahedron 5 are determined. The shapes of all remaining resulting mesh elements 9 may be determined based on the determined shape(s) of the resulting mesh element(s) between pairs of adjacent cutting planes 8 and/or by considering at least one of the cutting codes cc's associated with the cutting planes 8 which cut the respective tetrahedron 5.

In this way, for each tetrahedron 5 the shapes of the resulting mesh elements 9, into which the tetrahedron 5 is divided, and thus the shapes of all resulting mesh elements 9 of the layered component mesh 2 are determined.

Optionally, at least one initial mesh node 6 whose distance to a respective cutting plane 8 is less than one tenth of the smallest resulting mesh element thickness near this initial mesh node 6 is projected into the respective cutting plane 8.

All resulting mesh elements 9 are saved on a disk.

In FIG. 2 the triangular faces 11 of the tetrahedrons 5 of the tetrahedron mesh 4 are still visible and the trace of the cutting planes 8 may also be seen. The tetrahedron mesh 4 as well as the resulting layered component mesh 2 are fine enough to represent the geometry of the component 1 as precisely as desired and to model the behavior of the actual component 1 as precisely as desired.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

Although the present disclosure has been described in detail with reference to various embodiments, it is to be understood that the present disclosure is not limited by the disclosed examples, and that numerous additional modifications and variations may be made thereto by a person skilled in the art without departing from the scope of the disclosure.

1. A method for generating a component mesh of a component, wherein the component is configured to be built-up layer by layer in an additive manufacturing build-up process, wherein the component mesh is configured to be used in simulating the component and/or the additive manufacturing build-up process of the component, wherein the component mesh is configured to be used to get information on thermal issues during the build-up and to capture a preview on distortions that might arise due to the complex thermo-mechanical process during the additive manufacturing build-up process, and wherein the component mesh is generated by dividing a volume of the component into a finite number of elements, the method comprising:
providing a three-dimensional initial component mesh composed of initial mesh elements of uniform shape which comprise initial mesh nodes and initial mesh edges extending between the initial mesh nodes;
slicing the initial component mesh by at least one cutting plane such that initial mesh elements are divided into at least two resulting mesh elements, wherein at the intersection points of the at least one cutting plane with edges of initial mesh elements resulting mesh nodes are defined;
determining a position of each initial mesh element with respect to each cutting plane and thus which initial mesh element is divided into resulting mesh elements and which initial mesh element is not divided; and
determining the shape of each resulting mesh element.

2. The method of claim 1, wherein the slicing of the initial component mesh comprises slicing the initial component mesh by several cutting planes which run parallel to each other to generate a component mesh composed of several mesh layers superimposed upon each other.

3. The method of claim 2, wherein the slicing of the initial component mesh further comprises selecting a distance between the cutting planes such that each initial mesh element is cut a maximum of three times.

4. The method of claim 1, wherein the providing of the three-dimensional initial component comprises providing a tetrahedron mesh composed of tetrahedron-shaped mesh elements each having four initial mesh nodes.

5. The method of claim 1, wherein the determining of the position of each initial mesh element comprises calculating, for each initial mesh element a cutting code cc or cutting codes cc's which indicate(s) the position(s) of the initial mesh element with respect to the cutting plane(s).

6. The method of claim 5, wherein the calculating of the cutting code cc of an initial mesh element related to a particular cutting plane comprises:
creating an unsorted list nᵤₛ={n_{us,1}, n_{us,2}, n_{us,3},. . . , n_{us,1}} of i characters n_{us,1}, n_{us,2}, n_{us,3}, . . . , n_{us,i}, such as numbers or letters, which represent the initial mesh nodes of the initial mesh element;
assigning a cutting index m_{us,1}, m_{us,2}, m_{us,3}, . . . , m_{us,i} to each initial mesh node, wherein an initial mesh node which is below the particular cutting plane is assigned the cutting index 0, an initial mesh node which is in the particular cutting plane is assigned the cutting index 1 and an initial mesh node which is above the particular cutting plane is assigned the cutting index 2;
creating an unsorted list mᵤₛ={m_{us,1}, m_{us,2}, m_{us,3}, . . . , m_{us,i}} of the i cutting indices m_{us,1}, m_{us,2}, m_{us,3}, . . . , m_{us,i};
sorting the cutting indices m_{us,1}, m_{us,2}, m_{us,3}, . . . , m_{us,i} of the list mᵤₛ={m_{us,1}, m_{us,2}, m_{us,3}, . . . , m_{us,i}} in ascending order to create a sorted list mₛ={m_{s,1}, m_{s,2}, m_{s,3}, . . . , m_{s,i}} and permutating the characters n_{us,1}, n_{us,2}, n_{us,3}, . . . , n_{us,i} of the list nᵤₛ={n_{us,1}, n_{us,2}, n_{us,3}, . . . , n_{us,i}} to create a sorted list nₛ={n_{s,1}, n_{s,2}, n_{s,3}, . . . , n_{s,i}} which is sorted in correspondence with the sorted list mₛ={m_{s,1}, m_{s,2}, m_{s,3}, . . . , m_{s,i}}; and
calculating the cutting code cc using the sorted cutting indices m_{s,1}, m_{s,2}, m_{s,3}, . . . , m_{s,i}.

7. The method of claim 6, wherein the cutting code cc which has one to four digits is calculated using the following formula:
cc=m_{s,1}*1000+m_{s,2}*100+m_{s,3}*10+m_{s,4}.

8. The method of claim 7, wherein, for each initial mesh element, it is determined whether the respective initial mesh element is cut by one or more cutting planes and divided into resulting mesh elements or not cut based on the calculated cutting codes cc's, wherein:
when a cutting code cc is 0 or 2222, the respective cutting plane does not cut the respective initial mesh element,
when a cutting code cc is 1 or 1222, one initial mesh node of the respective initial mesh element belongs to the respective cutting plane,
when a cutting code cc is 11 or 1122, one edge of the respective initial mesh element (5) belongs to the respective cutting plane,
when a cutting code cc is 111 or 1112, one face of the respective initial mesh element (5) belongs to the respective cutting plane,
when a cutting code cc is 2, 12, 22, 112, 122 or 222, the respective initial mesh element is cut by the respective cutting plane, and
when a cutting code cc is 1111, the respective initial mesh element is degenerated.

9. The method of claim 8, wherein, when it is determined that a respective initial mesh element is cut by only one cutting plane and thus divided into two resulting mesh elements, the shape of the two resulting mesh elements is determined by the cutting code cc associated with the respective initial mesh element and the cutting plane which cuts the respective initial mesh element, wherein:
when the cutting code cc is 2 or 222, this indicates that the cutting plane divides the initial mesh element in a triangular prism and a tetrahedron,
when the cutting code cc is 12 or 122, this indicates that the cutting plane divides the initial mesh element in a quadrangular pyramid and a tetrahedron,
when the cutting code cc is 22, this indicates that the cutting plane divides the initial mesh element in two triangular prisms, and
when the cutting code cc is 112, this indicates that the cutting plane divides the initial mesh element in two tetrahedrons.

10. The method according to of claim 8, wherein, when it is determined that a respective initial mesh element is cut by at least two cutting planes, a first cutting code cc1 associated with the respective initial mesh element and a first cutting plane and a second cutting code cc2 associated with the respective initial mesh element and a second cutting plane, the first and second cutting planes being adjacent to each other and cut the respective initial mesh element, are considered to determine the shape of one or two resulting mesh elements delimited by the first and second cutting planes between the first and second cutting planes within the respective initial mesh element, wherein:
when the first cutting code cc1 is 2, 12 or 112 and the second cutting code cc2 is 0 or 1, or when the first cutting code cc1 is greater than 1111 and the second cutting code cc2 is 0, 1, 11, 12, 111, 112, 122 or 222, this indicates that a tetrahedron is delimited by the first and second cutting planes,
when the first cutting code cc1 is 2, 12 or 112 and the second cutting code cc2 is 2, or when the first cutting code cc1 is 22 and the second cutting code cc2 is 0, 1 or 11, or when the first cutting code cc1 is 222 and the second cutting code cc2 is 0, 1, 11 or 111, or when the first cutting code cc1 is 222 and the second cutting code cc2 is 112, 122 or 222, or when the first cutting code cc1 is greater than 1111 and the second cutting code cc2 is 2 or 22, this indicates that a triangular prism is delimited by the first and second cutting planes,
when the first cutting code cc1 is 122 and the second cutting code cc2 is 0, 1 or 11, this indicates that a quadrangular pyramid is delimited by the first and second cutting planes,
when the first cutting code cc1 is 22 and the second cutting code cc2 is 22, this indicates that a hexahedron is delimited by the first and second cutting planes, when the first cutting code cc1 is 22 or 122 and the second cutting code cc2 is 12, or when the first cutting code cc1 is 122 and the second cutting code cc2 is 22, this indicates that a degenerated hexahedron is delimited by the first and second cutting planes,
when the first cutting code cc1 is 22 and the second cutting code cc2 is 2, or when the first cutting code cc1 is 222 and the second cutting code cc2 is 22, this indicates that a degenerated hexahedron and a tetrahedron are delimited by the first and second cutting planes,
when the first cutting code cc1 is 122 and the second cutting code cc2 is 2, or when the first cutting code cc1 is 222 and the second cutting code cc2 is 12, this indicates that two triangular prisms, one of which is degenerated, are delimited by the first and second cutting planes, and
when the first cutting code cc1 is 222 and the second cutting code cc2 is 2, this indicates that two triangular prisms are delimited by the first and second cutting planes.

11. The method claim 10, wherein the cases in which two resulting mesh elements are delimited by the first and second cutting planes within the respective initial mesh element are due to the fact that, when the trace of the first and second cutting planes in a tetrahedron face of the respective initial mesh element defines a pentagon, the pentagon is divided into a quadrangle and a triangle.

12. The method of claim 1, further comprising:
projecting at least one initial mesh node, especially all initial mesh nodes, whose distance to a cutting plane is less than a predetermined threshold value, in particular less than one tenth of the smallest resulting mesh element thickness near this initial mesh node, into the cutting plane.

13. The method of claim 1, further comprising:
saving all resulting mesh elements which replace the initial mesh elements on a storage medium.

14. The method of claim 1, wherein the at least one cutting plane is a boundary plane of a boundary of the component, and
wherein resulting mesh elements outside the boundary are excluded from the component mesh.

15. The method of claim 1, further comprising:
thermally simulating, mechanically simulating, and/or thermos-mechanically simulating, with the generated component mesh, the component and/or an additive manufacturing build-up process of the component.

16. (canceled)

17. A non-transitory computer-readable medium comprising instructions which, when executed on at least one computer, cause the at least one computer to:
provide a three-dimensional initial component mesh composed of initial mesh elements of uniform shape which comprise initial mesh nodes and initial mesh edges extending between the initial mesh nodes;
slicing the initial component mesh by at least one cutting plane such that initial mesh elements are divided into at least two resulting mesh elements, wherein at the intersection points of the at least one cutting plane with edges of initial mesh elements resulting mesh nodes are defined;
determining a position of each initial mesh element with respect to each cutting plane and thus which initial mesh element is divided into resulting mesh elements and which initial mesh element is not divided; and
determining the shape of each resulting mesh element.

18. The method of claim 2, wherein the several cutting planes are uniformly spaced from each other.

19. The method of claim 2, wherein the slicing of the initial component mesh further comprises selecting a distance between the cutting planes such that each initial mesh element is cut a maximum of two times.

20. The method of claim 12, wherein all initial mesh nodes are projected.

21. The method of claim 12, wherein the predetermined threshold is less than one tenth of a smallest resulting mesh element thickness near the respective projected initial mesh node.
